(19) United States
(12) Patent Application Publication
(10) Pub. No.: US 2012/0242836 A1
(43) Pub. Date: Sep. 27, 2012

(54) RESELLER VIDEO SURVEILLANCE SYSTEM TECHNICAL AND SALES SUPPORT PLATFORM

(75) Inventor: Eugene Michael Szatkowski, Antioch, IL (US)

(73) Assignee: SECURE-I, INC., Des Plaines, IL (US)

(21) Appl. No.: 13/070,031

(22) Filed: Mar. 23, 2011

(51) Int. Cl. H04N 7/18

(52) U.S. Cl. 348/150; 348/E07.085

(57) ABSTRACT

A computer-implemented interactive collaboration system and methods allowing for guided sales support, provisioning, installation, and troubleshooting of internet enabled video surveillance monitoring systems. In an illustrative implementation, a computing environment comprises a video surveillance system provisioning and sales support engine (VSSPSE) having at least one instruction generating and communicating to one or more cooperating resellers of one or more internet-enabled video surveillance monitoring systems data representative of sales support, provisioning, installation, and/or troubleshooting for specified and/or installed one or more internet-enabled video surveillance monitoring systems. In an illustrative operation, a reseller can interact with the VSSPSE to provide data representative of an installation site. Responsive to the received data, the VSSPSE can generate and communicate data to the reseller to assist the reseller in selecting the appropriate equipment for and/or provision/troubleshoot existing equipment for a selected installation site as part of the reseller's sales/support functions with their customers.

### BACKGROUND

The advent of “cloud computing” has availed a number of applications delivered over the Internet that allow organizations and individuals alike to store, process, retrieve, and manage various cloud-based applications. Such cloud applications are easily accessible through any device having a web-connected browser. Cloud applications are pervasive and are used for many purposes including media sharing, banking, electronic mail communications, sales organization and management, document collaboration and presentation, facility monitoring, security, and file sharing. These applications can be applied for various industries including medical, legal, finance, manufacturing, telecommunications, and have found their way for certain government applications. In the context of premises security, various cloud and non-cloud applications exist that allow for real time monitoring, storage, and retrieval of digitally captured video surveillance data to ensure that a premises is secure from unwanted threats.

Current non-cloud security solutions generally capture analog and/or digital video surveillance data of a selected site location that is stored on a device that is generally kept on premises of the site location. Often, such devices require constant supervision by premises personnel to back-up stored data in case of disaster recovery. Additionally, often, such devices run one or more computing applications as well as possible firmware that might require periodic updates which can cause a delay in capturing vital video surveillance data when being updated. Comparatively, current cloud-based video surveillance systems rely on the use of Internet Protocol addressable video surveillance cameras that communicate to a centralized video surveillance capture server when storing, managing, and retrieving video surveillance. With cloud-based video surveillance systems, updates to the video surveillance server application/firm ware can be accomplished through a single central update thereby increasing efficiency.

However, even with cloud-based video surveillance systems, there are various drawbacks including efficient provisioning of video surveillance equipment as well as identifying various site location configuration limitations that render certain designs and use of certain video surveillance equipment infeasible and can drastically effect the operability of the video surveillance systems. Often, video surveillance equipment manufacturers and cloud-based video surveillance service operators work through a network of sales channel resellers (e.g., value added resellers) and installers to sell video surveillance systems to customers. These resellers are often charged with working with the end customers (e.g., industrial, commercial, and/or residential customers) to finalize a design for as well as install, provision, and troubleshoot installed video surveillance systems. Since the manufacturers and/or service operators for cloud-based video surveillance systems do not work directly with customers, relying instead on the resellers to engage in these critical tasks, resellers often become hesitant to recommend cloud-based video-surveillance systems to potential customers to alleviate any design, provisioning, installation, and troubleshooting issues that arise when working with such cloud-based video surveillance systems. In the event that a reseller overcomes such hesitation, often is the case that the reseller is slow to identify, respond, and correct possible design, provisioning, and/or installation issues that do arise with the operation of a cloud based video surveillance system. Such current practice leads to frustration on the customer's part as well as hampers adoption of such services by customers directly impacting service operators and manufacturers revenue.

Advantageously, resellers can immediately benefit from interaction with a centralized electronic video surveillance/monitoring provisioning and sales platform that would allow resellers to provide data representative of a customer site location variables (e.g., physical size, type of Internet connectivity, site layout, etc.) to the platform for recommendations regarding an optimal design for a video surveillance system for the given customer site location. Additionally, the advantageous platform can provide one or more operations/features to the reseller through a web-enabled application to allow the reseller to provision, troubleshoot, and configure an installed video surveillance system.

From the foregoing, it is appreciated that there exists a need for systems and methods that are aimed to ameliorate the shortcomings of existing practices.

### SUMMARY

A computer-implemented interactive collaboration system and methods allowing for guided sales support, provisioning, installation, and troubleshooting of internet enabled video surveillance monitoring systems. In an illustrative implementation, a computing environment comprises a video surveillance system provisioning and sales support engine (VSSPSE) having at least one instruction generating and communicating to one or more cooperating resellers of one or more internet-enabled video surveillance monitoring systems data representative of sales support, provisioning, installation, and/or troubleshooting for specified and/or installed one or more internet-enabled video surveillance monitoring systems. In the illustrative implementation, the VSSPE operates as part of a video surveillance provisioning and sales support platform that provides one or more features and/or operations to a cooperating reseller through a web-enabled browser computing application regarding design, provisioning, installation, and configuration of one or more video surveillance systems. In the illustrative implementation the video surveillance provisioning and sales support platform cooperates with one or more data stores having data representative comprising any of reseller profile information, video provisioning and sales support guidelines and data, video monitoring guidelines and data, and video component product data.

In an illustrative operation, a reseller can interact with the VSSPSE to provide data representative of an installation site. Responsive to the received data, the VSSPSE can generate and communicate data based on data retrieved from one or more of the herein described data stores to the reseller to assist the reseller in selecting the appropriate equipment for and/or provision/troubleshoot existing equipment for a selected installation site as part of the reseller's sales/support functions with their customers. In the illustrative operation, operating the web-enabled browser computing application on the cooperating reseller's computing environment, a cooperating reseller can additionally perform using the web-enabled browser computing application one or more Internet connectivity tests to ensure and confirm the data throughput of the site location.

In another illustrative operation, operating the web-enabled browser application the cooperating reseller can directly communicate with various Internet-enabled (cloud enabled) video surveillance equipment as part of provisioning, configuring, and or troubleshooting one or more components of a given video surveillance system.

Other features of the herein described systems and methods are further described below.

### BRIEF DESCRIPTION OF THE DRAWINGS

The interactive systems and methods for an interactive reseller video surveillance system technical and sales support platform are described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a block diagram showing the cooperation of exemplary components of another illustrative implementation in accordance with the herein described systems and methods;

FIG. 4 is a block diagram showing an illustrative block representation of an illustrative interactive centralized video surveillance system reseller technical and sales support system in accordance with the herein described systems and methods;

FIG. 5 is a block diagram describing the interaction of various components of an exemplary centralized video surveillance system reseller technical and sales support system in accordance with the herein described systems and methods;

FIG. 6 is a block diagram describing the interaction of various components of an exemplary centralized video surveillance system reseller technical support system in accordance with the herein described systems and methods;

FIG. 7 is a flow diagram showing illustrative processing performed when performing reseller video surveillance system technical support operations in accordance with the herein described systems and methods; and

FIG. 8 is a flow diagram showing illustrative processing performed when performing reseller video surveillance system sales support operations in accordance with the herein described systems and methods.

### DETAILED DESCRIPTION

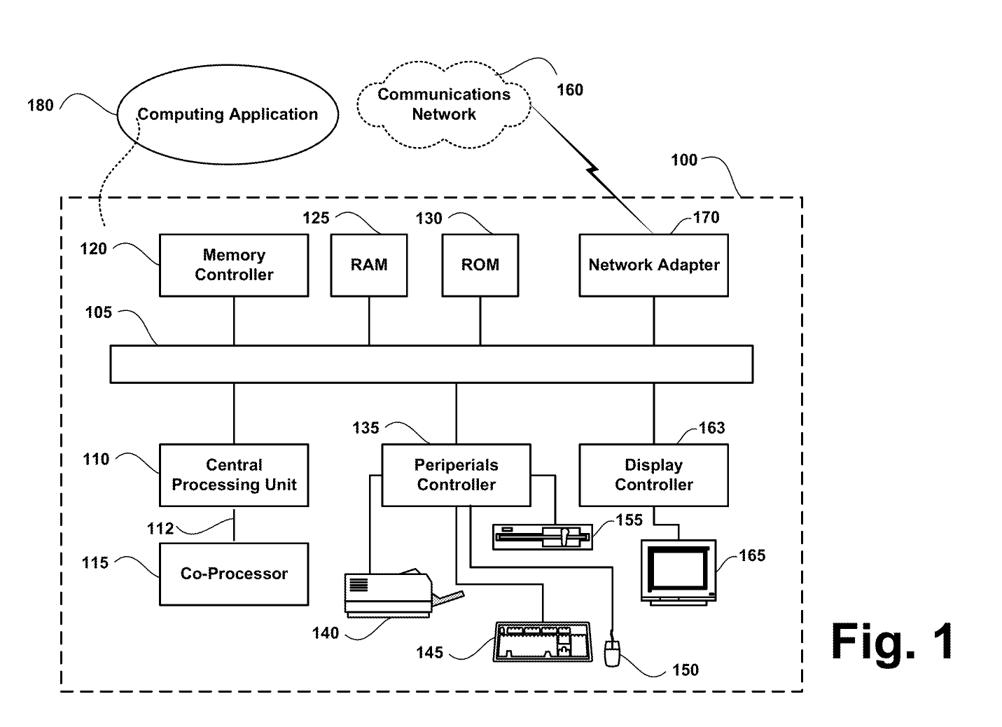

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

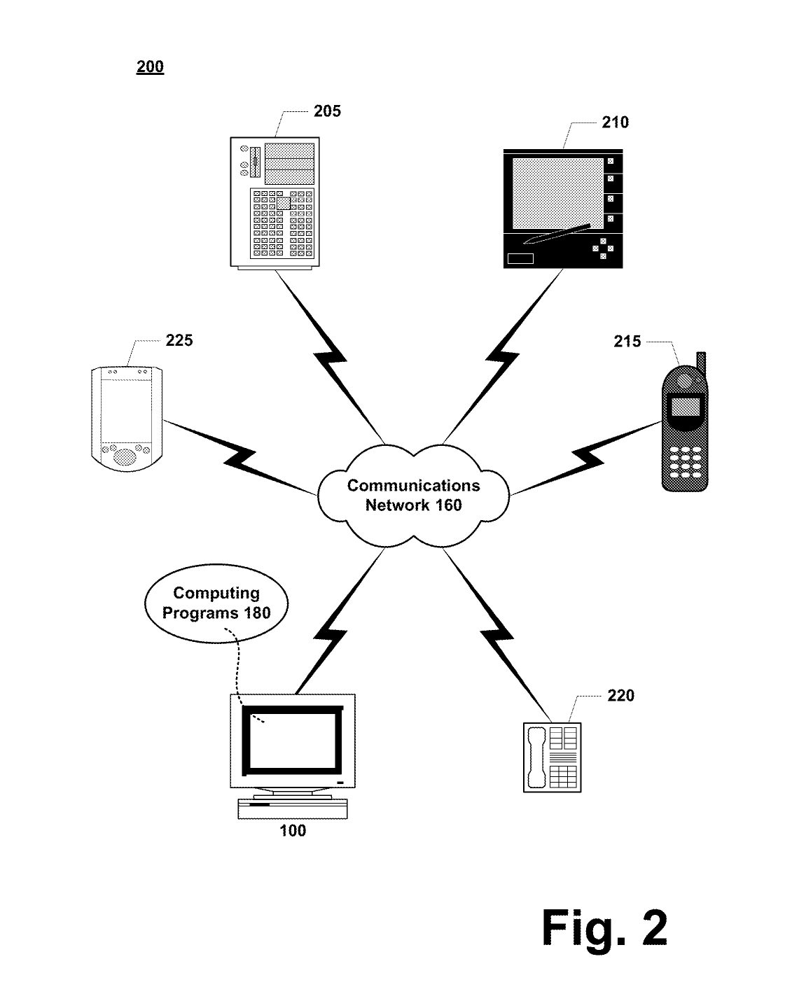

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

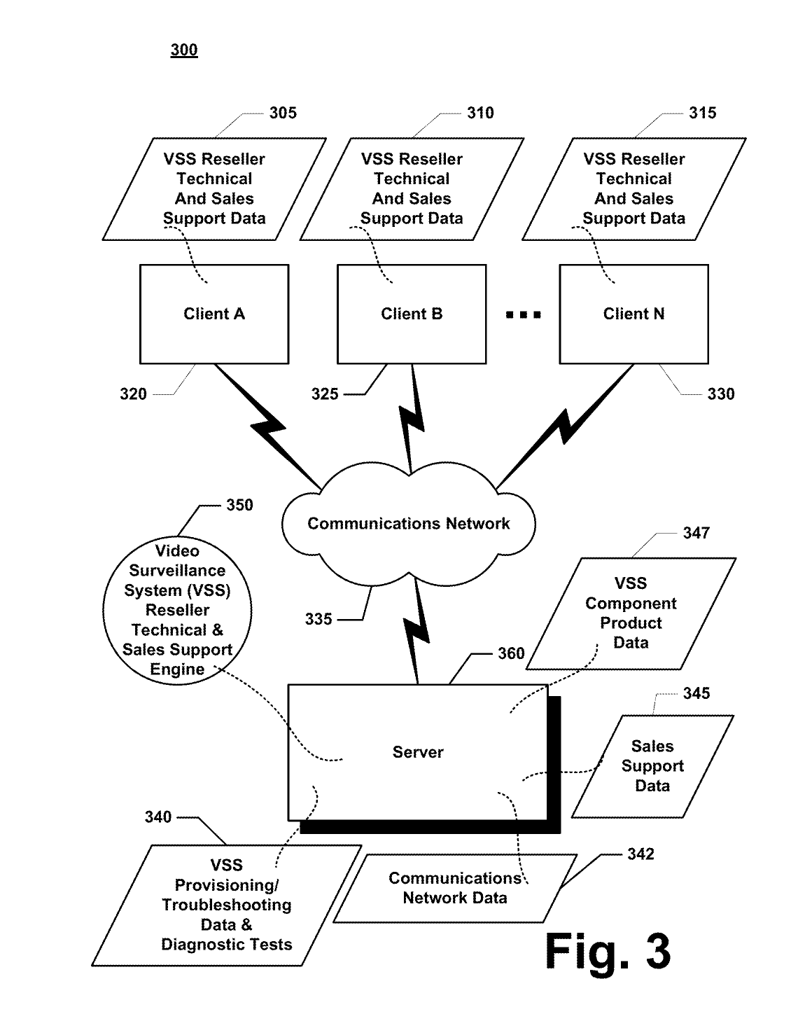

FIG. 3 shows an illustrative implementation of exemplary reseller video surveillance system (VSS) technical and sales platform 300. As is shown in FIG. 3, exemplary reseller VSS technical and sales support platform 300 comprises client computing environment 320, client computing environment 325 up to and including client computing environment 330, communications network 335, server computing environment 360, VSS reseller technical and support engine 350, VSS provisioning/troubleshooting data and diagnostic tests 340, communications network data 342, sales support data 345, and video component product data 347. Also, as is shown in FIG. 3, reseller VSS technical and sales support platform 300 can comprise a plurality of VSS reseller technical and sales support data (e.g., including but not limited to design data, provisioning data, configuration data, installation data, troubleshooting data, and diagnostic tests) 305, 310, and 315 which can be displayed, viewed, stored, electronically transmitted, and printed from client computing environments 320, 325, and 330, respectively.

In an illustrative operation, client computing environments 320, 325, and 330 can communicate and cooperate with server computing environment 360 over communications network 335 to provide requests for and receive VSS reseller technical and sales support data 305, 310, and 315. In the illustrative operation, VSS reseller technical and sales support engine 350 can operate as a web-based computing application on server computing environment 360 to provide one or more instructions to server computing environment 360 to process requests for VSS reseller technical and sales support data 305, 310, and 315 and to electronically communicate VSS reseller technical and sales support data 305, 310, and 315 to the requesting client computing environment (e.g., client computing environment 320, client computing environment 325, or client computing environment 335). As part of processing requests for VSS reseller technical and sales support data 305, 310, and 315, VSS reseller technical and sales support engine 350 can utilize a plurality of data comprising VSS provisioning/troubleshooting data and diagnostic tests 340, communications network data/tests 342, sales support data 345, and/or VSS component product data 347. Also, as is shown in FIG. 3, client computing environments 320, 325, and 330 are capable of processing VSS reseller technical and sales support data 305, 310, and 315 for display and interaction to one or more participating users (not shown).

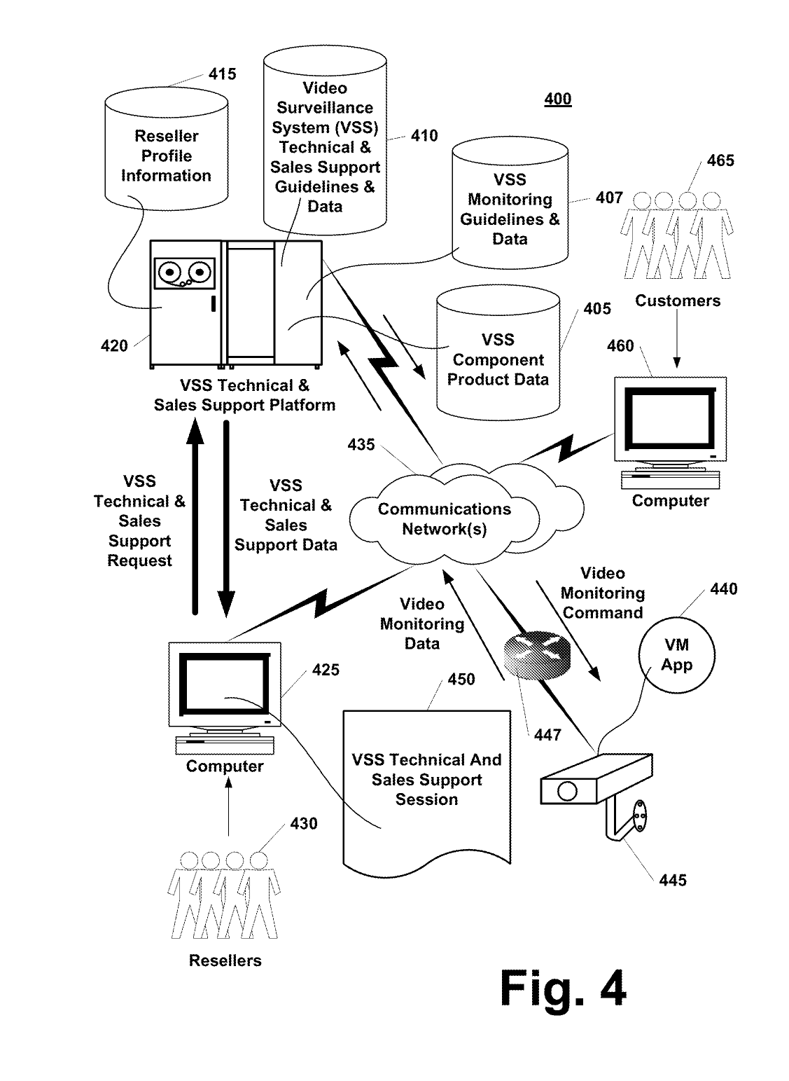

FIG. 4 shows a detailed illustrative implementation of exemplary video surveillance system (VSS) reseller technical and sales support environment 400. As is shown in FIG. 4, reseller VSS technical and sales support environment 400 comprises VSS technical and sales support platform 420, reseller profile information data store 415, VSS technical and sales support guidelines data store 410, VSS component product data store 405, and VSS monitoring guidelines data store 407, reseller computing environment 425, participating resellers 430, VSS camera component 440 operating a VSS monitoring application, exemplary router 447, customer computing environment 460, and customers 465. Additionally, as is shown in FIG. 4, reseller VSS technical and sales support environment 400 can comprise VSS technical and sales support session content (e.g., live and/or stored) 450 which can be displayed, viewed, transmitted and/or printed from reseller computing environment 425.

In an illustrative implementation, VSS technical and sales support platform 420 can be electronically coupled to reseller computing environment 425, exemplary VSS camera component 445 through exemplary router 447, and customer computing environment 460 via communications network 435. In the illustrative implementation, communications network can comprise fixed-wire and/or wireless intranets, extranets, and the Internet.

In an illustrative implementation, VSS technical and sales support platform 420 can comprise a web-based computing application operable on one or more web servers (not shown) allowing access to resellers 430, VSS camera component 440, and customers 465 through a web browser (not shown) using the Internet as the shared communications network.

In an illustrative operation, resellers 430 can interact with a web-enabled computing application (not shown) operating on reseller computing environment 425 to provide requests to initiate a VSS technical and sales support session 450 that are passed across communications network 435 to VSS technical and sales support platform 420. In the illustrative operation, VSS technical and sales support platform 420 can process requests for a VSS technical and sales support session 450 and cooperate with interactive reseller profile information data store 415, VSS technical and sales support guidelines data store 410, VSS component product data store 405, and VSS monitoring guidelines data store 407 to generate a VSS technical and sales support session for use by resellers 430, VSS camera component 445, and customers 465.

In an illustrative implementation, reseller profile information data store 415 can comprise data representative including but not limited to, a reseller's geographic coverage, the reseller's customer contacts, the reseller's purchase power, and the reseller's choice for various VSS components. In the illustrative implementation, VSS technical and sales support guideline data store 410 can comprise one or more business rules that can be applied to data representative of one or more of a site location's variables (e.g., a site location's physical size, the site location's Internet connectivity capability, the site location's physical layout) and/or one or more VSS components (e.g., cameras, routers, storage devices, etc.)

specifications data by exemplary VSS technical and sales support platform 420 to generate reseller technical and/or sales data representative of a recommended VSS design, a recommended VSS layout, recommended VSS provisioning, recommended VSS configuration, recommended VSS installation, and/or recommend VSS troubleshooting. VSS component product data store 405 can comprise data representative of various specifications for various VSS components that are used by the reseller including but not limited to Internet addressable video surveillance cameras, routers, and electronic storage devices. VSS monitoring guidelines data store 407 can comprise data representative of centralized storage and retrieval of video surveillance data being collected and transmitted from an illustrative site location (e.g., house, business, factory, etc.)(not shown) to a centralized video surveillance storage server farm (not shown) as provided by an exemplary VSS service operator (not shown).

In an illustrative operation, as part of VSS technical and sales support session 450, one or more participating resellers 430 can interact with exemplary VSS technical and sales support platform 420 using reseller computing environment 425 over communications network 435 to submit data representative of one or more resellers' profile for processing and storage by exemplary VSS technical and sales support platform 420 in reseller profile information data store 415. In the illustrative operation, as part of VSS technical and sales support session 450, exemplary VSS technical and sales support platform 420 can communicate various VSS technical and sales support data (e.g., generated using and/or retrieved from one or more cooperating data stores 405, 407, 410, and 415 to one or more participating resellers 430 over communications network 435 in accordance with the exemplary features/operations described herein.

In another illustrative operation, customers 465 can interact with exemplary VSS technical and sales support platform 420 using customers' computing environment 460 to request various technical and sales support data for one or more VSS components that the customers maintain and utilize as part of their video surveillance program.

Exemplary features/operations of exemplary VSS technical and sales support environment 400 can comprise: providing a recommended design/layout of an optimal VSS for a selected site location premised on various site location variables and/or VSS component specification data; providing recommended technical support data including but not limited to VSS provisioning data, VSS configuration data, VSS diagnostic tests that can be executed on the VSS, VSS installation data, and VSS troubleshooting data.

In an illustrative implementation, armed with the generated technical and sales support data provided by exemplary VSS technical and sales support environment 400, resellers 430 can more confidently recommend, install, provision, configure, and troubleshoot VSS that they would otherwise shy away from due to a perception that such VSS are cumbersome and difficult to independently design, deploy, provision, configure, install, and/or troubleshoot.

It is appreciated by one of ordinary skill in the art that although the operations and features regarding reseller VSS technical and sales support are described in FIG. 4 as requiring a client/server architecture, that such description is merely illustrative of a single illustrative implementation and that the inventive concepts described herein can be performed by various computing environment architectures including but not limited to a single stand-alone computing application having all of the associated data stores residing local to the single stand-alone computing application.

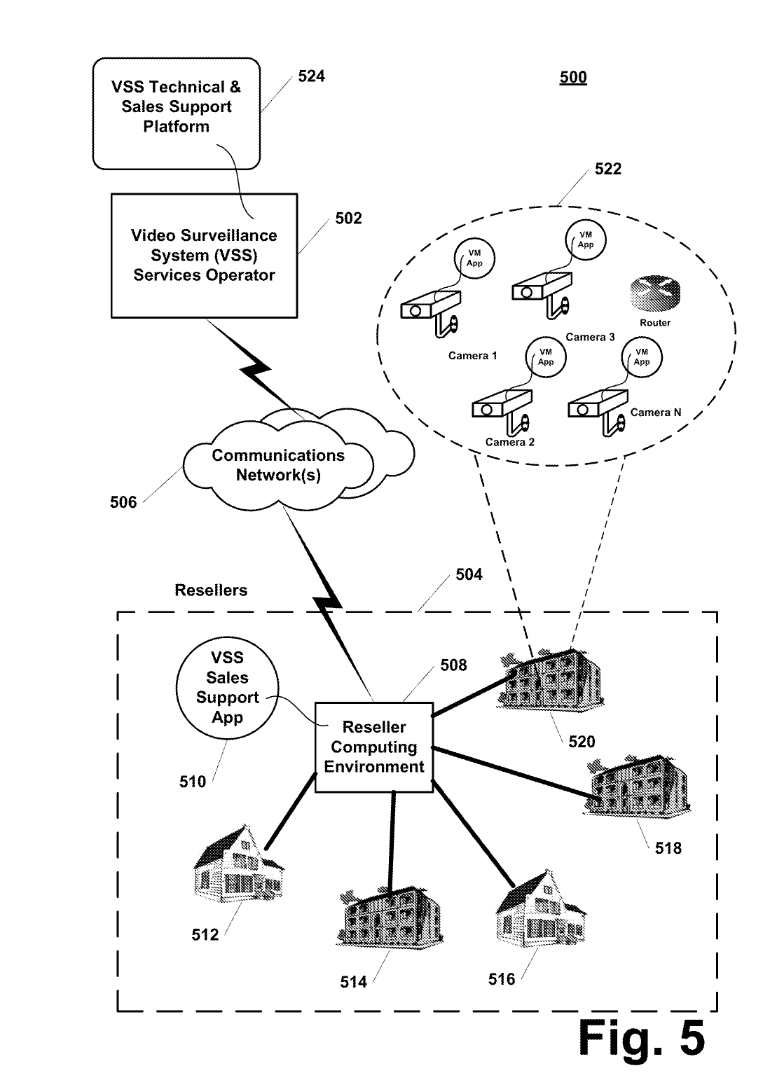

FIG. 5 shows illustrative interaction of various cooperating components of exemplary centralized electronic video surveillance system (VSS) reseller sales support environment 500 when performing sales support functions. As is shown, exemplary VSS reseller sales support environment 500 comprises VSS services operator computing environment 502 cooperating with VSS technical and sales support platform 524, communications network(s) 506, reseller environment 504. Further, as is shown in FIG. 5, in an illustrative implementation, reseller environment can comprise reseller computing environment 508 operating VSS sales support computing application 510, as well as various commercial and residential customer site locations 512, 514, 516, 518, and 520, respectively, at which a reseller can design, install, provision, configure, and/or troubleshoot an exemplary video surveillance system. Further as is shown in FIG. 5, one or more exemplary site locations, 512, 514, 516, 518, and 520 may have various video surveillance equipment deployed at such site locations (e.g., camera 1, camera 2, camera 3, up to camera N, as well as an exemplary router and other video surveillance components (not shown)).

In an illustrative operation, reseller computing environment 508 operating VSS sales support computing application 510 can operatively communicate a request for VSS sales support data from VSS Service operator 502 over communications network 506 regarding the design and/or deployment of various VSS components 522 at one more customer site locations 510, 512, 514, 516, 518, or 520, respectively. Responsive to receiving the request for sales support data, VSS services operator 502 cooperates with VSS technical and sales support platform 524 (e.g., 420 of FIG. 4) to process the received request and provide requested sales support data regarding recommended use of various VSS components 522 as part of a recommended design premised on one or more site location (e.g., 512, 514, 516, 518, and 520) variables including but not limited to the site's physical location, Internet connectivity capability of the site location, as well as physical layout of the site location. The generated site location specific sales support data can then be communicated by VSS services operator 502 to the VSS sales support computing application 510 operable on reseller computing environment 508.

In an illustrative implementation, exemplary sales support computing application 510 can comprise a stand-alone computing application or a web browser computing application. In the context of a stand-alone computing application illustrative implementation, the stand-alone computing application can also comprise a local data store having video surveillance system technical and/or sales support data as well as one or more diagnostic tests for use in troubleshooting various video surveillance system components. In another illustrative implementation, exemplary sales support computing application 510 can comprise a web browser computing application that is operative to access various technical and sales support data as well as various diagnostic tests from VSS technical and sales support platform 524 over communications network 506.

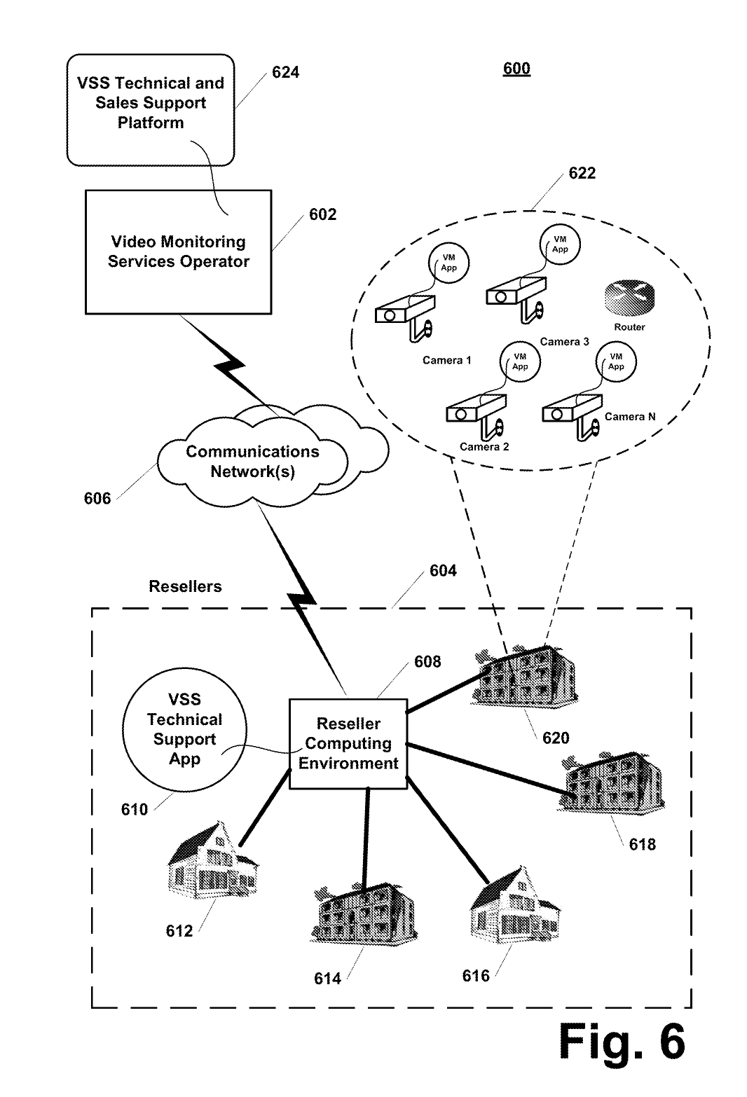

FIG. 6 shows illustrative interaction of various cooperating components of exemplary centralized electronic video surveillance system (VSS) reseller technical support environment 600 when performing sales support functions. As is shown, exemplary VSS reseller technical support environment comprises VSS services operator computing environment 602 cooperating with VSS technical and sales support platform 624, communications network(s) 506, reseller environment 504. Further, as is shown in FIG. 6, in an illustrative implementation, reseller environment can comprise reseller computing environment 608 operating VSS sales support computing application 610, as well as various commercial and residential customer site locations 612, 614, 616, 618, and 620, respectively, at which a reseller can design, install, provision, configure, and/or troubleshoot an exemplary video surveillance system. Further as is shown in FIG. 6, one or more exemplary site locations, 612, 614, 616, 618, and 620 may have various video surveillance equipment deployed at such site locations (e.g., camera 1, camera 2, camera 3, up to camera N, as well as an exemplary router and other video surveillance components (not shown)).

In an illustrative operation, reseller computing environment 608 operating VSS technical support computing application 610 can operatively communicate a request for VSS technical support data and/or diagnostic tests from VSS Service operator 602 over communications network 606 regarding the provisioning, configuration, and/or troubleshooting of various VSS components 622 at one more customer site locations 610, 612, 614, 616, 618, or 620, respectively. Responsive to receiving the request for technical support data and/or one or more diagnostic tests, VSS services operator 602 cooperates with VSS technical and sales support platform 624 (e.g., 420 of FIG. 4) to process the received request and provide requested technical support data and/or one or more diagnostic tests regarding recommended the provisioning, configuration, and/or troubleshooting of various VSS components 622 premised on one or more VSS component 622 specifications as well as one or more site location (e.g., 612, 614, 616, 618, and 620) variables including but not limited to the site's physical location, Internet connectivity capability of the site location, as well as physical layout of the site location. The generated site location/VSS component specific technical support data and/or one more diagnostic tests can then be communicated by VSS services operator 602 to the VSS sales support computing application 610 operable on reseller computing environment 608.

In an illustrative implementation, exemplary sales support computing application 610 can comprise a stand-alone computing application or a web browser computing application. In the context of a stand-alone computing application illustrative implementation, the stand-alone computing application can also comprise a local data store having video surveillance system technical and/or sales support data as well as one or more diagnostic tests for use in troubleshooting various video surveillance system components. In another illustrative implementation, exemplary sales support computing application 610 can comprise a web browser computing application that is operative to access various technical and sales support data as well as various diagnostic tests from VSS technical and sales support platform 624 over communications network 606.

Is appreciated by one of ordinary skill in the art that although the sales support operations and technical support operations are described in FIG. 5 and FIG. 6 as being performed by two separate computing applications (e.g., 510 and 610)

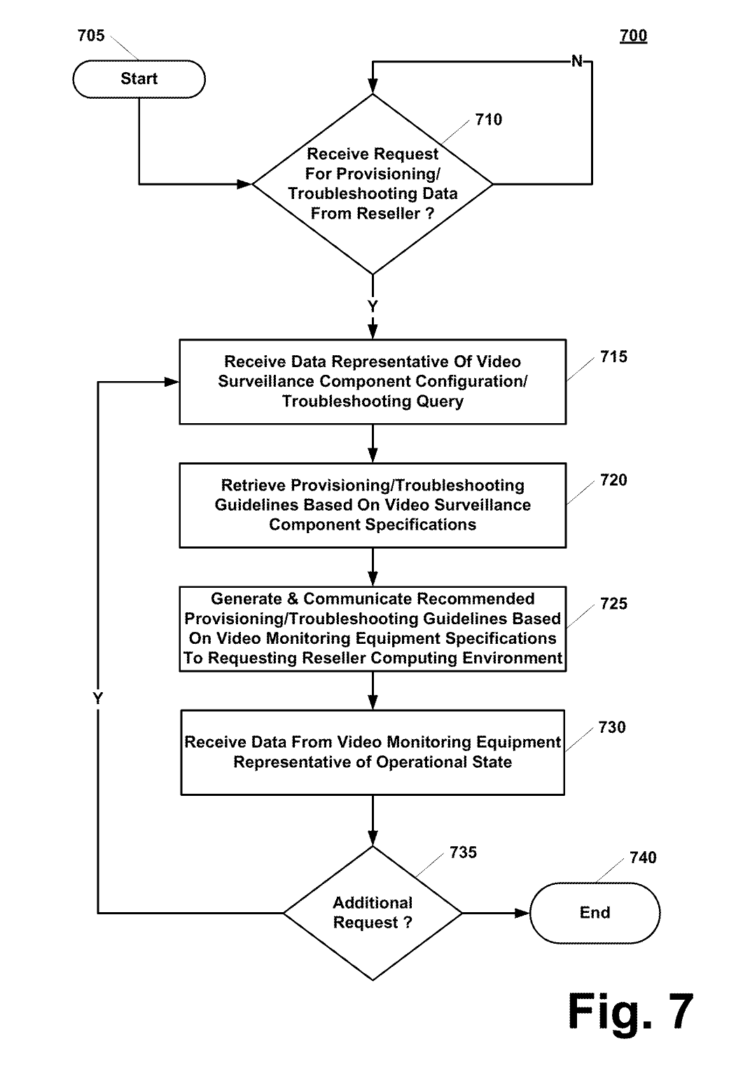

FIG. 7 shows exemplary method 700 describing illustrative processing performed when providing technical support data by exemplary VSS technical and sales support platform 420 (not shown) to resellers of video surveillance systems. As is shown, processing begins at block 705 and proceeds to block 710 where a check is performed to determine if data representative of a request for provisioning/troubleshooting data from a reseller is received by exemplary VSS technical and sales support platform 420 of FIG. 4 (not shown). If the check at block 710 indicates that provisioning/troubleshooting data is not being requested from a cooperating reseller (e.g., a cooperating reseller computing environment), processing reverts to block 710 and continues there from.

However, if the check at block 710 indicates that provisioning/troubleshooting data is being requested from a cooperating reseller computing environment, responsive to the data request exemplary VSS technical and sales support platform 420 (not shown) operatively receives additional data representative of one or more video surveillance component configuration queries at block 815. Processing then proceeds to block 820 where one or more video surveillance equipment provisioning/troubleshooting guidelines based on the received video surveillance component specifications are retrieved by exemplary VSS technical and sales support platform 420 of FIG. 4 (not shown) from one or more cooperating data stores (not shown). The received video surveillance component specification data along with the retrieved configuration/installation data is processed at block 725 to generate recommended provisioning/troubleshooting guidelines data for communication to the requesting cooperating reseller computing environment (not shown).

In an illustrative operation, the processing at block 725 can comprise applying one or more business rules (e.g., provisioning/troubleshooting guidelines) to the received video surveillance component specification data premised on one or more video surveillance component variables comprising the type of video surveillance components (e.g., Internet Protocol addressable auto-provisioning video cameras, data communication routers, data communication repeaters, data communication network firewalls, and other components used when deploying digital video surveillance systems), the quantity of desired video surveillance components, the type and version of software being executed by the video surveillance components, and the manufacturer of the video surveillance components. Additionally, in the illustrative operation, the applied one or more business rules can also take into consideration additional data including but not limited to including the installed site's physical location, the site's Internet connectivity capability, and the site's physical layout

From block 725, processing proceeds to block 730 where data representative of the video surveillance component operational state is received by exemplary VSS technical and sales support platform 420 (not shown) from one or more cooperating reseller computing environments. Processing then proceeds to block 735 where a check is performed to determine data representative of additional requests for provisioning/troubleshooting recommendation data is received by exemplary VSS technical and sales support platform 420 (not shown). If the check at block 835 indicates that additional requests for data are received, processing reverts to block 815 and proceeds from there. However, if the check at block 835 indicates that there are no additional requests, processing proceeds to block 840 and terminates.

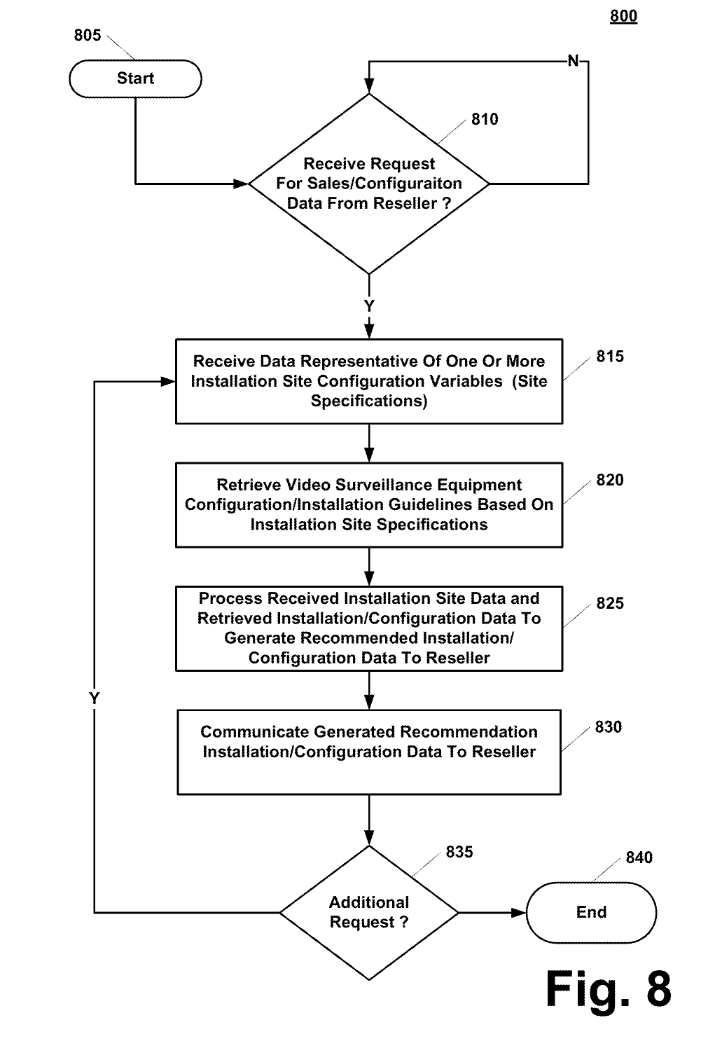

FIG. 8 shows exemplary method 800 describing illustrative processing performed when providing sales support data by exemplary VSS technical and sales support platform 420 of FIG. 4 (not shown) to resellers of video surveillance systems. As is shown, processing begins at block 805 and proceeds to block 810 where a check is performed to determine if data representative of a request for sales/configuration data from a reseller is received by exemplary VSS technical and sales support platform 420 of FIG. 4 (not shown). If the check at block 810 indicates that sales/configuration data is not being requested from a cooperating reseller (e.g., a cooperating reseller computing environment), processing reverts to block 810 and continues there from.

However, if the check at block 810 indicates that that sales/configuration data is being requested from a cooperating reseller computing environment, responsive to the data request exemplary VSS technical and sales support platform 420 (not shown) operatively receives additional data representative of one or more installation site configuration variables for one or more installation sites at block 815. Processing then proceeds to block 820 where one or more video surveillance equipment configuration/installation guidelines based on the received installation site specifications are retrieved by exemplary VSS technical and sales support platform 420 of FIG. 4 (not shown) from one or more cooperating data stores (not shown). The received site installation data along with the retrieved configuration/installation data is processed at block 825 to generate recommended installation/configuration data to the requesting cooperating reseller computing environment (not shown).

In an illustrative operation, the processing at block 825 can comprise applying one or more business rules (e.g., configuration/installation guidelines) to the received site installation data premised on one or more site location variables including the site's physical location, the site's Internet connectivity capability, and the site's physical layout. Additionally, in the illustrative operation, the applied one or more business rules can also take into consideration additional data including but not limited to the type of video surveillance components (e.g., Internet Protocol addressable auto-provisioning video cameras, data communication routers, data communication repeaters, data communication network firewalls, and other components used when deploying digital video surveillance systems), the quantity of desired video surveillance components, the type and version of software being executed by the video surveillance components, and the manufacturer of the video surveillance components.

From block 825, processing proceeds to block 830 where the generated recommendation installation/configuration data is communicated by exemplary VSS technical and sales support platform 420 (not shown) to one or more cooperating reseller computing environments. Processing then proceeds to block 835 where a check is performed to determine data representative of additional requests for installation/configuration recommendation data is received by exemplary VSS technical and sales support platform 420 (not shown). If the check at block 835 indicates that additional requests for data are received, processing reverts to block 815 and proceeds from there. However, if the check at block 835 indicates that there are no additional requests, processing proceeds to block 840 and terminates.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments, including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A system for providing sales support to video monitoring/surveillance system resellers, comprising:
a computing processor;
one or more data stores comprising data representative of reseller profile information, video surveillance system provisioning and sales support guidelines and data, video surveillance guidelines and data, and video component product data;
computing memory communicatively coupled with the computing processor and the one or more data stores, the computing memory having stored therein instructions that, if executed by the computing processor, cause the computing processor to perform operations comprising:
receiving data representative of selected one or more customer site locations from a cooperating reseller computing environment, the customer site location data comprising data representative of the one or more site locations' physical size, the one or more site locations' Internet connectivity capability, and the one or more site locations' physical layout;
processing the one or more site location data received according to one or more selected video surveillance provisioning and sales support guidelines operatively retrieved from the one or more cooperating data stores;
generating video surveillance reseller sales support data representative comprising recommended video surveillance component types and quantities to be use for a site location based on the received one or more site location data and the applied one or more selected video surveillance provisioning and sales support guidelines; and
communicating the generated video surveillance reseller sales support data to the reseller computing environment.

2. The system as recited in claim 1, wherein the receiving of data representative of selected one or more customer site locations comprises receiving data representative of installed video surveillance equipment.

3. The system as recited in claim 1, wherein the receiving data representative of selected one or more customer site locations comprising receiving data representative of the reseller's profile information.

4. The system as recited in claim 3, further comprising processing the received data representative of the reseller's profile information to identify one or more types of selected video surveillance equipment components for installation at the one or more site locations.

5. The system as recited in claim 1, further comprising communicating data to the reseller computing environment representative of an Internet connectivity speed test.

6. The system as recited in claim 5, further comprising receiving data from the reseller computing environment representative of one or more results of the Internet connectivity speed test.

7. The system as recited in claim 1, wherein the instructions comprise a web-enabled server-side computing application communicatively coupled over a communications network to one or more computer servers and to the reseller computing environment.

8. The system as recited in claim 8, wherein the reseller computing environment comprises a web browser computing application operative to communicate data to and from the web-enabled server-side computing application.

9. The system as recited in claim 1, wherein the instructions comprise a stand-alone Internet-enabled computing application cooperating with a local copy of the one or more data stores.

10. The system as recited in claim 1, wherein the processing the one or more site location data received comprises applying one or more business rules contained in the provisioning and support guidelines.

11. A method for providing sales support to video monitoring/surveillance system resellers, comprising:
receiving data representative of selected one or more customer site locations from a cooperating reseller computing environment, the customer site location data comprising data representative of the one or more site locations' physical size, the one or more site locations' Internet connectivity capability, and the one or more site locations' physical layout;
processing the one or more site location data received according to one or more selected video surveillance provisioning and sales support guidelines operatively retrieved from the one or more cooperating data stores;
generating video surveillance reseller sales support data representative comprising recommended video surveillance component types and quantities to be use for a site location based on the received one or more site location data and the applied one or more selected video surveillance provisioning and sales support guidelines; and
communicating the generated video surveillance reseller sales support data to the reseller computing environment.

12. The method as recited in claim 11, further comprising receiving data representative of selected one or more customer site locations comprising receiving data representative of the reseller's profile information.

13. The method as recited in claim 11, further comprising receiving data representative of installed video surveillance equipment.

14. The method as recited in claim 11, further comprising communicating data to the reseller computing environment representative of an Internet connectivity speed test.

15. The method as recited in claim 14, further comprising receiving data from the reseller computing environment representative of one or more results of the Internet connectivity speed test.

16. A system for providing technical support to video monitoring/surveillance system resellers, comprising:
a computing processor;
one or more data stores comprising data representative of reseller profile information, video surveillance system provisioning and sales support guidelines and data, video surveillance guidelines and data, and video component product data;
computing memory communicatively coupled with the computing processor and the one or more data stores, the computing memory having stored therein instructions that, if executed by the computing processor, cause the computing processor to perform operations comprising:
receiving data representative of selected one or more video surveillance components installed and/or to be installed at one or more site locations from a cooperating reseller computing environment, the one or more video surveillance components data comprising data representative of the hardware and/or software specifications of one or more installed video surveillance components, the operational state of the one or more video surveillance components, the network configuration of the one or more video surveillance components, and the Internet connectivity capability of the site location wherein the one or more video surveillance components are installed:
processing the one or more video surveillance components data received according to one or more selected video surveillance provisioning and sales support guidelines operatively retrieved from the one or more cooperating data stores;
generating video surveillance reseller technical support data comprising provisioning guidelines for installed/to be installed one or more video surveillance components, one or more troubleshooting procedures to troubleshoot installed/to be installed one or more video surveillance components, and one or more installation procedures to install/configure one or more video surveillance components based on the received one or more site location data and the applied one or more selected video surveillance provisioning and sales support guidelines; and
communicating the generated video surveillance reseller technical support data to the reseller computing environment.

17. The system as recited in claim 16, further comprising communicating data to the reseller computing environment representative of an Internet connectivity speed test.

18. The system as recited in claim 17, further comprising receiving data from the reseller computing environment representative of one or more results of the Internet connectivity speed test.

19. The system as recited in claim 16, wherein the instructions comprise a web-enabled server-side computing application communicatively coupled over a communications network to one or more computer servers and to the reseller computing environment.

20. The system as recited in claim 19, wherein the reseller computing environment comprises a web browser computing application operative to communicate data to and from the web-enabled server-side computing application.

21. The system as recited in claim 16, wherein the instructions comprise a stand-alone Internet-enabled computing application cooperating with a local copy of the one or more data stores.

22. The system as recited in claim 16, wherein the processing the one or more site location data received comprises applying one or more business rules contained in the provisioning and support guidelines.

23. A method for providing technical support to video monitoring; surveillance system resellers, comprising:
receiving data representative of selected one or more video surveillance components installed and/or to be installed at one or more site locations from a cooperating reseller computing environment, the one or more video surveillance components data comprising data representative of the hardware and/or software specifications of one or more installed video surveillance components, the operational state of the one or more video surveillance components, the network configuration of the one or more video surveillance components, and the Internet connectivity capability of the site location wherein the one or more video surveillance components are installed;
processing the one or more video surveillance components data received according to one or more selected video surveillance provisioning and sales support guidelines operatively retrieved from the one or more cooperating data stores;
generating video surveillance reseller technical support data comprising provisioning guidelines for installed/to be installed one or more video surveillance components, one or more troubleshooting procedures to troubleshoot installed/to be installed one or more video surveillance components, and one or more installation procedures to install/configure one or more video surveillance components based on the received one or more site location data and the applied one or more selected video surveillance provisioning and sales support guidelines; and
communicating the generated video surveillance reseller technical support data to the reseller computing environment.

24. The system as recited in claim 23, further comprising communicating data to the reseller computing environment representative of an Internet connectivity speed test.

25. The system as recited in claim 24, further comprising receiving data from the reseller computing environment representative of one or more results of the Internet connectivity speed test.

26. The system as recited in claim 23, further comprising applying one or more business rules contained in the provisioning and support guidelines.
